(19) United States
(12) Patent Application Publication
(10) Pub. No.: US 2025/0388385 A1
(43) Pub. Date: Dec. 25, 2025

(54) LONG-DURATION POLYLACTIC ACID-BASED SHIPPERS AND ASSOCIATED METHODS

(71) Applicant: Lifoam Industries, LLC, Greer, SC (US)

(72) Inventors: Saumitra Bhargava, Clarksville, MD (US); Jonathan Godfrey, Joppa, MD (US)

(21) Appl. No.: 19/244,237

(22) Filed: Jun. 20, 2025

Related U.S. Application Data
(60) Provisional application No. 63/662,105, filed on Jun. 20, 2024.

(51) Int. Cl. B65D 81/38; B29C 65/00; B29C 65/02; B29K 667/00; B29L 31/00

(52) U.S. Cl. CPC B65D 81/3816; B29C 65/02; B29C 66/71; B29C 66/727; B65D 81/3818; B65D 81/3823; B29K 2667/046; B29L 2031/712

(57) ABSTRACT

Insulated shippers having vacuum insulated panels (VIPs) adhered to PLA-based bead foam are provided. The insulated shippers advantageously extend the effective thermal performance of the VIPs and enable the formation of thermal shippers capable of at least 8 days, and in some cases more than 14 days, of effective thermal performance, enabling the formation of thermal shippers capable of delivering thermally sensitive goods to more remote destinations without substantially increasing the cost of the shipper.

### CROSS-REFERENCE TO RELATED APPLICATION

This application claims priority to U.S. Provisional Patent Application No. 63/662,105, filed Jun. 20, 2024, which is hereby incorporated by reference.

### FIELD OF THE DISCLOSURE

This disclosure relates generally to molded foam articles and, in particular, relates to bead foam thermal shippers composed of low-density bead foam articles formed from polylactic acid and adhered to vacuum insulated panels (VIPs).

### BACKGROUND

Bead foam articles are used in a variety of diverse industries including thermal insulation and protective packaging, construction, infrastructure support, foodservice, and consumer products. Bead foam articles are commonly produced from expandable polystyrene (EPS), which has a well-known manufacturing process. However, EPS-based bead foam articles suffer from a variety of drawbacks that prevent not only recycling the EPS article, but also repurposing the EPS article for secondary uses.

Hybrid packaging including foam, corrugate, and tape; foam, tape, and film; or molded pulp, corrugate, and tape are also common. EPS or another foam is often used to cover an article being protected. Once covered, the article may then be placed in corrugate or film. Alternatively, the packaging process may start with a corrugated box and EPS or another foam may be added to the base and sides of the box. However, this may be a difficult process that requires time and often results in failures. The foam either must be held in place or attached to the article being protected with tape or hot melt adhesive. Protecting the goods being shipped is important to end user satisfaction. Not following the process correctly can lead to breakage, complaints, and added expense. Many of the packaging steps are challenging to automate, especially aspects of the process in which tape is used.

Consumer-facing foam articles such as insulated shippers are commonly used for shipping meal kits, confectionary products, cakes, other perishable goods, and pharmaceutical items such as vaccines. These insulated shippers are normally discarded by the end-user after their initial purpose has been served, and discarded EPS products contribute over 1,300 tons of waste to landfills in the United States every day.

Prior attempts to reduce molded bead foam article waste have included a shift towards biobased and compostable foam materials as alternatives to EPS. For example, expandable polylactic acid (PLA or EPLA) can be used to produce bead foam articles having insulative and protective properties equal to or superior to those of EPS, but with the added benefit of being compostable. However, bead foam articles rarely have utility in any secondary use beyond the initial application for which the molded bead foam article was made.

Furthermore, existing EPS-based shippers are normally capable of maintaining low temperatures, even with the addition of phase-change material such as ice packs, for a maximum of around 3 days. In warm climates, this duration is reduced. As a result, temperature sensitive goods and medications cannot be shipped to certain climates and destinations before spoilage.

One prior attempt to extend the duration of thermal shippers include vacuum insulated panels (VIPs) which are characterized by a gas-tight enclosure that is evacuated and sealed within a rigid material such as polypropylene (PP). By evacuating the air from within the VIP and forming an insulated shipper from VIPs, the thermal transfer regime through which thermal energy must escape includes a vacuum, substantially reducing thermal energy loss and extending the life of the thermal shipper. This performance is sometimes enhanced by VIP manufacturers by including additional layers or covers on the VIP, such as foil, a layer of EPS, or another form of insulation. However, even a VIP-based shipper has a maximum effective shipment duration of around 5 days depending on the amount of phase change material included and the climate through which the shipper is shipped.

There remains certain shipment channels and destinations that are incapable of receiving certain commodities without extremely expensive air-mail services. As these destinations are often highly remote and sometimes impoverished, the people in these destinations simply cannot receive these commodities. Since high-performance thermal shippers are often used to ship, among other things, life-saving medications, there are some people who suffer from preventable illnesses solely because they live in a remote location.

Accordingly, improved thermal shippers are needed for overcoming one or more of the technical challenges described above.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a graph comparing thermal performance of PLA shippers with and without a foil layer.

FIG. 2 is a graph comparing thermal performance of VIP shippers with and without PLA.

FIG. 3 is a graph comparing thermal performance of VIP shippers with PLA and with EPS.

FIG. 4 is a graph demonstrating thermal performance of a PLA and VIP based shipper with a foil layer.

### DETAILED DESCRIPTION

Thermal shippers are provided herein including at least one bead foam article that has been adhered to a vacuum insulated panel (VIP). In particular, it has been unexpectedly discovered that forming the thermal shippers from bead foam comprising polylactic acid (PLA) and adhering it to a VIP enables the formation of a thermal shipper with superior thermal performance to any existing thermal shipper solution. In some cases, the thermal shipper unexpectedly possess an R-value greater than the mere sum of its parts, indicating favorable enhancement of both the thermal performance of PLA and of the VIP and resulting in a thermal shipper capable of at least 8 days of thermal performance.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” with reference to dimensions refers to the dimension plus or minus 10%.

### Overview of Adhesion Process

The ability for PLA-based bead foam to adhere to various substrates has been previously explored, such as in U.S. patent application Ser. No. 18/356,617 to Lifoam Industries, LLC, filed Jul. 21, 2023. It was discovered that when a surface is rapidly heated to between (and inclusive of) 250 to 450° F. and a piece of polylactic acid resin (PLA) foam is pressed on the heated surface of an object, adhesion occurs between the PLA bead foam article and the heated surface within a second to 5 seconds. The heating process of the surface is rapid enough that the bulk of the object remains at a room temperature (for example a human operator may be able to hold one portion of the object while heating another portion of the object to which the PLA foam is adhered). In this manner, a PLA bead foam article may be quickly adhered to any type of surface by heating the surface and pressing the PLA molded foam against the surface. This process may be performed without requiring an additional adhesive to provide between the foam and the object to which the foam is being adhered. The adhesion force may be sufficiently strong that the PLA bead foam article may remain adhered to the surface, however, the PLA bead foam article may be removable from the surface if sufficient force is applied to pull the PLA bead foam article from the surface. After removal, the surface of the PLA is free from debris and has the same appearance as the bulk, unmodified or unadhered surface of PLA after simply wiping the surface.

It has been discovered that adhesion to the polypropylene-based surface of a standard VIP is likewise possible with the same case and advantages as those described with respect to other materials, but with unexpectedly favorable thermal transfer characteristics. In other words, the PLA bead foam article supplements the thermal performance of the VIP and advantageously mitigates VIP drawbacks and vice-versa, producing a thermal shipper with thermal performance greater than one would expect from simply combining the materials.

### Long Duration Thermal Shippers

Insulated shippers are disclosed herein. In some embodiments, the insulated shipper includes at least one bead foam article comprising expandable polylactic acid (PLA or EPLA). As used herein, a “bead foam article” refers to an article formed from a polymeric bead foam that has gone through an expansion and bead molding process, such as a PLA molded foam. Thus, reference herein to “at least one beam foam article” (or like terms) may similarly refer to a PLA molded foam. The article may be in the form of a two-dimensional panel or a three-dimensional structure such as a box. In some embodiments, a plurality of bead foam articles are joined together using suitable means to form a more complicated structure.

As used herein, an “insulated shipper,” sometimes referred to as a “thermal shipper,” is a container configured for shipping thermally sensitive commodities while maintaining a desired temperature within the shipper. The industry standard for a “desired temperature” for thermal shippers is 8° C. or less. Insulated shippers or thermal shippers are characterized by having walls resistant to thermal energy transfer, i.e., walls formed from foam, insulation, or another material with a favorable R-value, which is a measure of insulation's ability to resist heat transfer.

In some embodiments, the at least one bead foam article is adhered to a surface of the vacuum insulated panel (VIP) by heating either the surface of the VIP or a surface of the at least one bead foam article and pressing the at least one bead foam article against the surface of the VIP. It has been discovered that PLA bead foam rapidly adheres to the surface of VIPs.

As used herein, “vacuum insulated panel” and “VIP” refer to a gas-tight enclosure that is evacuated and sealed within a rigid material. VIPs often take the form of a substantially two-dimensional panel having a height and width substantially larger than its thickness. For example, the VIP may have dimensions such as 10″×10″×1.0″. The VIP normally has a substantially rectangular prism shape having 6 sides, but any suitable shape and size may be used provided the desired thermal energy retention is achieved. The rigid material surrounding and forming the evacuated enclosure is normally formed from a material such as polypropylene (PP), although any suitably rigid material may be used provided it provides sufficient protection against punctures that may eliminate the VIP's efficacy.

In some embodiments, the at least one bead foam article is pressed against the surface of the VIP for less than a second. In some instances, the at least one molded bead foam article may be pressed against the surface of the VIP for less than a few seconds (for example, less than five seconds). That is, in some instances, “rapid” adhesion may refer to adhesion that occurs between the PLA foam and the surface to which the PLA foam is being adhered in less than a second or seconds (however, this is merely exemplary). In this manner, the surface may only need to be heated for a short period of time to perform the adhesion.

In some embodiments, the at least one bead foam article is removable from the surface of the VIP. That is, the at least one bead foam article may be rapidly adhered to the VIP while allowing for the foam to be removed from the VIP when the foam is no longer required. This is particularly advantageous in the context of VIPs because VIPs are expensive to produce and manufacturers often request consumers return the VIP after successful delivery. The ability to easily remove the bead foam article with no residue enables rapid re-use of the VIP for subsequent shipments. Furthermore, the VIPs may be disassembled and combined into a smaller or more efficient package for return to the original shipper.

In some embodiments, pressing the PLA bead foam against the surface of the VIP while the surface is heated may result in the PLA bead foam article being adhered to the surface with a bond equivalent to approximately 2-200 pound force peel strength. That is, the adhesion process described herein achieves a bond that is sufficiently strong to survive the shipment process, while also being sufficiently weak to allow for the PLA molded foam to be removed from the VIP. In this manner, the PLA bead foam may be recycled or composted while the VIP may be repurposed appropriately.

In some embodiments, the at least one bead foam article includes a pocket, and the at least one VIP is incorporated within the pocket. As used herein, a “pocket” refers to an enclosed or nearly enclosed space that may be formed within a single, monolithic piece of PLA bead foam or may be formed by the adhesion or joining of multiple pieces of PLA bead foam. The “pocket” may have a shape corresponding to the VIP to be incorporated within. For example, if the VIP intended to be incorporated within the pocket has a “panel” shape as described previously, such as a six-sided panel having dimensions 10″×10″×1.0″ other similar dimensions, the pocket likewise may have dimensions 10″×10″×1.0″. The pocket may have six sides, with one “side” being open so that the VIP may be inserted. This open side may subsequently be sealed by adhering an additional piece of PLA bead foam.

As described previously, VIPs are characterized by a gas-tight enclosure that has been evacuated. In order to remain effective, the VIP must be formed out of a material having sufficient rigidity to withstand the crumple forces by the environment acting on the evacuated space within the VIP. However, the material must also be sufficiently light to maintain the cost-benefit from forming a thermal shipper out of the VIP. Further still, the material must be sufficiently resistant to punctures because punctures in the surface of the VIP can destroy the vacuum produced in the evacuated space. A study performed by the Cold Climate Housing Research Center in 2018 concluded that, although VIPs work well as insulation, the largest challenge to overcome in their use is the fragility of the material. In order to mitigate the risk of puncture, some previous thermal shippers, such as the one described in U.S. Pat. No. 11,518,602 to Laminar Medica Ltd. include a custom-design phase change material layer designed to act as a barrier that may protect the integrity of the VIP. However, this custom phase-change material is suitable for use only with a precisely dimensioned thermal shipper and provides no impact protection in case the thermal shipper is dropped. Another thermal shipper described in U.S. patent application Ser. No. 17/013,574 to Cold Chain Technologies LLC mitigates the fragility of VIPs by designing a more complicated assembly and construction process for the shipper through the formation of recesses, troughs, channels, and other mechanical features. However, this design is more complicated and expensive to produce.

The incorporation of the VIP into a “pocket” within the bead foam article advantageously mitigates the fragility of the VIP by providing impact protection to all or most of the sides of the VIP. For example, a pocket in the bead foam article having an opening along the minor dimension enables insertion of the VIP in such a way that the major dimensions of the VIP are not exposed to and are protected from both the external environment and from the contents of the insulated shipper.

Furthermore, incorporating the VIP into a pocket specifically formed within a PLA-based bead foam article, as opposed to other bead foams such as EPS, has a number of advantages that are not realized by these other foams. First, PLA bead foam articles readily adhere to one another, as described herein and in U.S. patent application Ser. No. 18/356,617 to Lifoam Industries, LLC, filed Jul. 21, 2023. This adhesion eliminates any gaps that may permit thermal energy transfer, increasing the efficiency of the VIP inserted into the pocket by sealing the pocket closed with an additional piece of PLA bead foam. Second, PLA bead foam is capable of being molded in substantially greater thickness than EPS bead foam, as described in U.S. patent application Ser. No. 17/656,700 to Lifoam Industries, LLC, filed Mar. 28, 2022. This greater thickness enables the formation of a single, monolithic bead foam article having a pocket, rather than multiple disparate pieces of bead foam adhered together, which may further enhance the efficiency of the VIP by further sealing the pocket in which the VIP is inserted. EPS cannot readily adhere to the VIP without the use of an adhesive, which lessens the likelihood that the EPS can be easily removed from the VIP. EPS furthermore cannot be molded with a pocket and cannot self-adhere. PLA therefore represents a significant improvement over the use of EPS in VIP-based thermal shippers.

As will be described in further detail in the Examples, it has been unexpectedly discovered that the incorporation of PLA into a VIP-based thermal shipper is capable of maintaining a desired internal temperature for from about 1 day to about 3 days longer than an identical VIP-based thermal shipper that utilizes EPS. This improved performance may be attributed to a number of factors. First, the ability for PLA to self-adhere enables the ability to adhere a lid to the insulated shipper without an air gap. Thus, the internal cavity of the thermal shipper is air-tight or nearly air-tight. Second, the ability for PLA to be molded in thicker panels compared to other bead foams enables the formation of shipper walls with a higher R-value. Third, the ability to swiftly and easily adhere a layer of foil to PLA bead foam extends the effective thermal performance by upwards of a day.

In some embodiments, a foil may be adhered to an external surface of the insulated shipper to further enhance the thermal performance of the shipper. For example, the insulated shipper may include a cavity for a commodity and phase change material surrounded first by one or more bead foam articles, followed by one or more VIPs, followed by additional bead foam articles, and finally by a layer of foil adhered to an external surface of the outermost bead foam through the application of heat, as described herein.

In some embodiments, heating the surface of the VIP or the at least one bead foam article is performed using a heating element, wherein the heating element comprises a heated roller, a heated platen, a hot air gun, an infrared-emitting device, a conduction heater, an induction spot heater, steam, or heated fluids. Any of these heating elements may be used to heat a surface of the VIP or bead foam article such that the PLA bead foam article may be pressed against the surface of the VIP to adhere the PLA foam to the surface. In some embodiments, the VIP surface or bead foam article is heated to a temperature between (and inclusive of) 250° F. and 450° F. Heating the surface to such a temperature may allow for the rapid adhesion of the PLA foam to the surface of the VIP. These are merely examples of types of heating elements and any other type of element capable of heating a surface may also be used. These heaters can be operated with electricity, steam, thermal transfer fluids, kerosene, heating oil, solar, natural gas, for example.

In some embodiments, only a portion of the VIP surface or bead foam article is heated to adhere the at least one molded bead foam article to the VIP surface. That is, not all of the VIP surface to which the PLA foam is to be adhered needs to be heated to adhere the PLA foam to the surface or vice versa. This enables heating of the VIP surface of bead foam article by simply holding the material in one hand and applying heat with the other, for example. By way of another example, a single heating element of one size may be used to heat and facilitate adhesion of a variety of different VIP shapes and sizes and bead foam article shapes and sizes without multiple heating cycles, multiple heating elements, or the need to produce many different heating elements of various shapes and sizes.

In some embodiments, heating the at least one surface of the first molded bead foam article is performed without producing flammable gas. EPS-based molded bead foam articles are formed using a pentane blowing agent. As a result, EPS articles must be conditioned for upwards of a month in a warehouse to permit sufficient pentane degas in order to mitigate the flammability of EPS. PLA is produced without flammable blowing agent and thus can be heated immediately upon molding to later with no generation of flammable gas.

In some embodiments, the at least one molded bead foam article is at least partially machined. It has been unexpectedly discovered that machining a molded bead foam article formed from PLA produces up to 50% less waste than a comparable molded bead foam article formed from expandable polystyrene, and the dust that is produced is easily compostable and biodegradable. As used herein, “machined” refers to the process of cutting, drilling, milling, die-cutting and/or shaving the molded bead foam article in order to produce smaller molded foam article(s) or to shape the molded foam article. Machining processes may involve the use of lathes, cutting tools, hot wire, hot knives, rotary tools, die-cutting punches, drilling etc. When lathe, CNC, or water-jet machining EPS-based articles, micro and macroparticles of EPS are generated in the form of dust. This dust is not only undesirable as a messy byproduct of the machining process, but EPS-based foam dust remains incapable of recycling or composting. In addition, when machining PLA-based articles in a typical milling process using a fine cutting tool rotating at 30,000 rpm, there is a 40-60% reduction in fine particles that are produced compared to EPS-based molded articles under the same machining conditions. PLA articles can be painted with any number of commercially available paints, including those with solvents such as acetone. The ability to machine the PLA articles and paint the surface of PLA articles widens the potential use-cases for PLA foam adhesion to materials.

In some embodiments, the at least one molded bead foam article is an existing molded bead foam article having an initial intended use, such as an insulative piece of PLA-based bead foam included in a product packaging to product a product. In some embodiments, the existing piece of PLA-based bead foam was originally used as thermal protection for temperature-sensitive products, as impact protection for fragile products, or a combination thereof. Rather than discarding this PLA-based bead foam article, it may be used as described herein by adhering it to another substrate, enabling the use of the PLA-based molded bead foam article in a secondary use beyond the initial intended use, reducing overall waste attributed to the original thermal or impact packaging.

In some embodiments, the insulated shipper is configured to maintain a desired temperature for at least 8 days. In other words, when the insulated shipper is formed as described herein, loaded with a temperature sensitive commodity, and loaded with phase change material such as ice packs, the temperature within the insulated shipper can be maintained at a desired temperature, such as below 8° C., for at least 8 days without reloading the shipper with “fresh” phase change material. In some embodiments, the insulated shipper is capable of maintaining the desired temperature for at least 9 days, at least 10 days, at least 11 days, at least 12 days, at least 13 days, at least 14 days, or longer, depending on the size of the shipper, the amount of phase change material, and the climate to which the shipper is sent.

### Methods for Producing Insulated Shippers

Methods for producing insulated shippers are also disclosed herein. In one aspect, the methods include producing insulated shippers as described above. In another aspect, the method includes adhering at least one bead foam article to a surface of a vacuum insulated panel (VIP) by heating the VIP surface and/or a surface of the bead foam article and pressing the at least one bead foam article against the VIP surface. In some embodiments, the at least one bead foam article comprises a plurality of foam beads comprising polylactic acid.

In some embodiments, the at least one bead foam article and the VIP surface are adhered together without using an adhesive. In some embodiments, the at least one bead foam article is removable from the VIP surface. In some embodiments, heating the VIP surface and/or the surface of the at least one bead foam article is performed using a heating element, wherein the heating element comprises a heated roller, a heated press, steam, heat transfer fluid, a hot air gun, an infrared-emitting device, a conduction heater, or an induction spot heater. In some embodiments, the VIP surface and/or the surface of the at least one bead foam article is heated to a temperature between or including 250° F. and 450° F. In some embodiments, only a portion of the VIP surface and/or the surface of the at least one bead foam article is heated to adhere the at least one bead foam article to the VIP surface. In some embodiments, the at least one bead foam article is pressed against the VIP surface for less than a second. In some embodiments, heating the surface of the at least one bead foam article is performed without producing flammable gas.

### EXAMPLES

The disclosure may be further understood with reference to the following non-limiting examples.

### Example 1: Effect of Foil Layer on PLA-Based Shipper

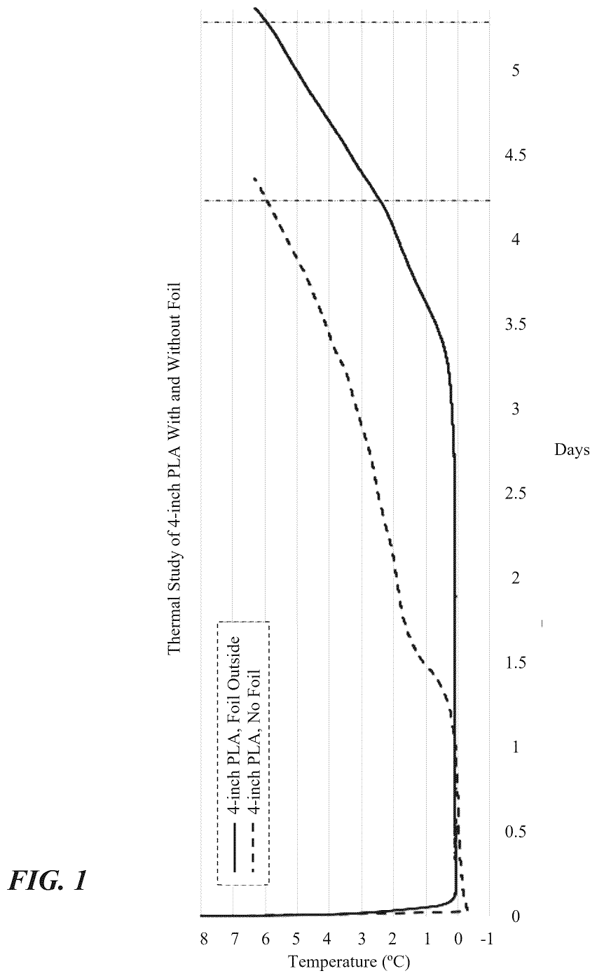

Two insulated shippers were produced as described herein. Each shipper had 4″ thick sidewalls formed from PLA to produce an open-top box having an inner cavity dimension of 10″×10″×10″. One of the two shippers included an external layer of foil adhered to the PLA sidewalls. A payload was prepared comprising a datalogger and two refrigerated gel packs weighing 32 oz within a small corrugated box. The payload was placed within the cavity of the shipper and surrounded by 128 oz of frozen gel packs. A 4″ thick plank of PLA was adhered via self-adhesion to the top of each open-top box to seal the cavity. No corrugate was used on the external surface of either shipper. Each shipper was placed within a temperature-controlled chamber set between 15 to 23° C. and the temperature of the datalogger recorded every 5 minutes for 5.5 days. The results are displayed in FIG. 1.

Although a typical industry standard for thermal shippers is to maintain a temperature of less than 8° C., for this Example, the desired temperature range was established as less than 6° C. to shorten the test duration. As shown in FIG. 1, the PLA-based shipper without foil maintained the desired temperature range for 4.2 days, while the PLA-based shipper with foil maintained the desired temperature range for 5.2 days.

### Example 2: Effect of PLA on VIP-Based Shipper

A commercially available VIP-based shipper was compared to a PLA and VIP-based shipper. The commercially available VIP shipper was Catalog No. 95054-968 VIP Shipper, available commercially from VWR International, LLC, Radnor, Pennsylvania, USA. This commercial shipper includes 0.5″ VIPs. The second shipper was constructed by joining six 0.5″ VIPs together to form a cavity having dimensions 9″×8″×6″, and adhering a 3″ thick plank of PLA bead foam to the outside of each VIP. The first and second shippers had identical cavity dimensions.

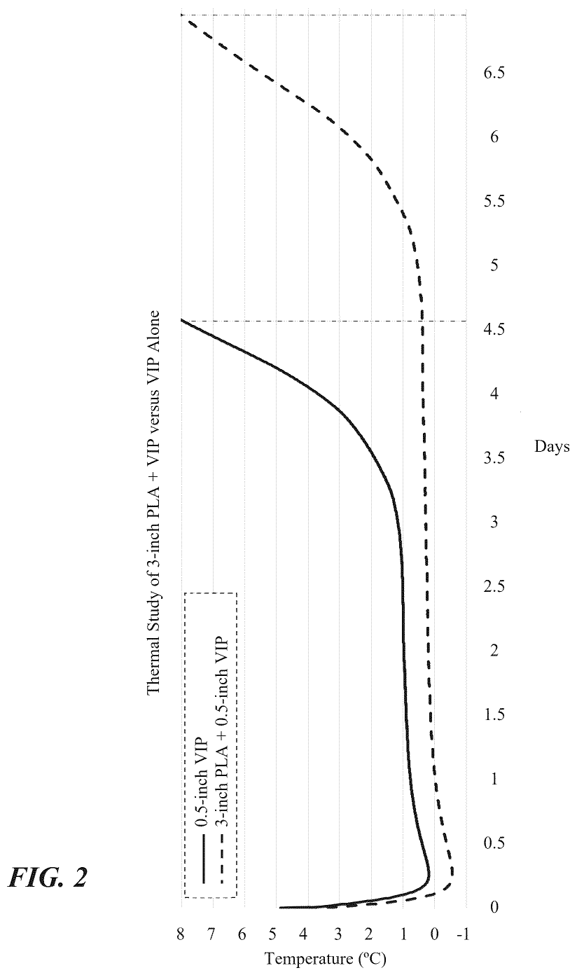

Both shippers were loaded with a payload comprising a datalogger and two refrigerated gel packs weighing 32 oz within a small corrugated box. 96 oz of frozen gel packs were packed around the payload in each shipper. Each shipper was placed within a temperature-controlled chamber set between 15 to 23° C. and the temperature of the datalogger recorded every 5 minutes. The results are displayed in FIG. 2.

As shown in FIG. 2, the commercially available VIP shipper maintained the desired temperature (6° C. or less) for 4.5 days. The PLA and VIP shipper of the present disclosure maintained the desired temperature for 6.9 days.

### Example 3: Comparison of PLA/VIP Shipper With EPS/VIP Shipper

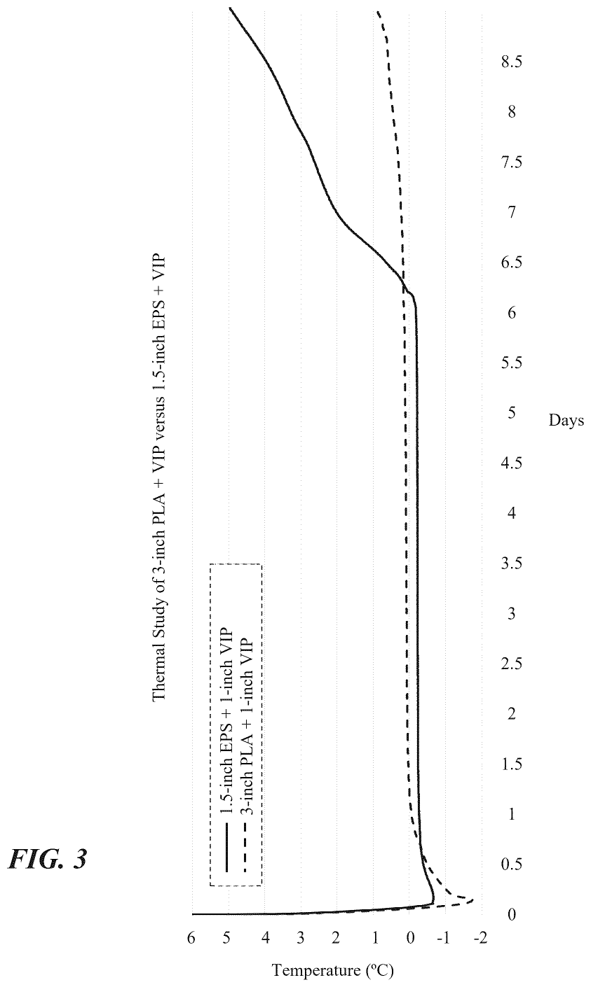

A commercially available EPS and VIP-based shipper was compared to a PLA and VIP-based shipper. The commercially available EPS and VIP shipper was Catalog No. 13500-582 VIP Shipper, available commercially from VWR International, LLC, Radnor, Pennsylvania, USA. This commercial shipper is formed from 1″ thick VIPs enclosed in a 1.5″ thick EPS outer shell. The second shipper was constructed by joining six 1″ thick VIPs together to form a cavity having an internal volume of 0.5 ft³ and enclosed in a 3″ thick PLA outer shell. Both shippers were loaded with a payload comprising a datalogger and two refrigerated gel packs weighing 32 oz within a small corrugated box. 96 oz of frozen gel packs were packed around the payload in each shipper. Each shipper was placed within a chamber and the temperature of the datalogger recorded every 5 minutes. The results are displayed in FIG. 3.

As shown in FIG. 3, the experiment was stopped after 9 days. In that time, the temperature in the EPS and VIP shipper increased to 5° C. while the temperature in the PLA and VIP shipper increased to only 1° C. It is expected that the EPS and VIP based shipper would maintain the desired temperature for about 11 days while the PLA and VIP shipper would maintain the desired temperature for about 13 days.

### Example 4: Performance of PLA and VIP Shipper With Foil Layer

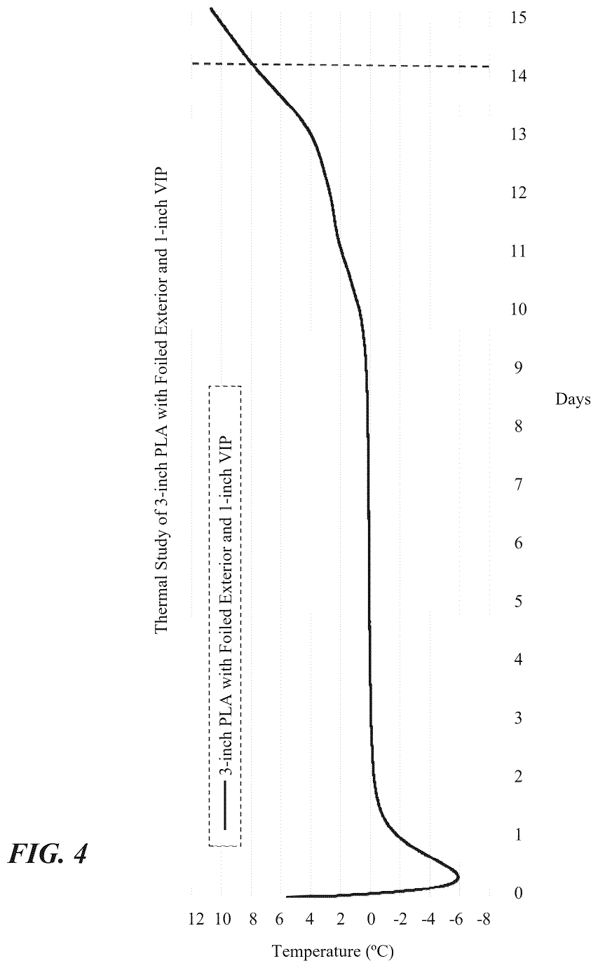

The thermal shipper comprising PLA and VIPs used in Example 3 was modified by a layer of foil adhered to the outside. The same payload and phase change material described in Example 3 was used. The results are displayed in FIG. 4.

As shown in FIG. 4, the shipper maintained the payload below a typical industry-standard 8° C. for 14.2 days. This represents a significant improvement over commercial solutions available today and can enable the shipping of thermally sensitive goods to even the most remote destinations.

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirt and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure it not to be seen as limited by the foregoing described, but is only limited by the scope of the appended claims.

That which is claimed is:

1. An insulated shipper comprising:
at least one bead foam article comprising polylactic acid, and
at least one vacuum insulated panel (VIP),
wherein the at least one bead foam article is adhered to a surface of the VIP by heating the surface and/or the at least one bead foam article and pressing the at least one bead foam article against the surface.

2. The insulated shipper of claim 1, wherein the at least one bead foam article and the surface are adhered together without using an adhesive.

3. The insulated shipper of claim 1, wherein the at least one bead foam article is removable from the surface.

4. The insulated shipper of claim 1, wherein the at least one bead foam article comprises a pocket, and wherein the at least one VIP is incorporated within the pocket.

5. The insulated shipper of claim 4, wherein the at least one VIP is adhered within the pocket without the use of adhesive.

6. The insulated shipper of claim 4, wherein the VIP is not exposed to contents of the insulated shipper or to the environment when positioned within the pocket.

7. The insulated shipper of claim 1, wherein the at least one bead foam article comprises an external surface of the insulated shipper, and wherein the insulated shipper further comprises a foil adhered to the external surface of the at least one bead foam article.

8. The insulated shipper of claim 7, wherein the foil is adhered to the at least one bead foam article without using an adhesive.

9. The insulated shipper of claim 1, wherein the heated VIP surface and/or the heated bead foam article is heated to a temperature between or including 250° F. and 450° F.

10. The insulated shipper of claim 1, wherein only a portion of the VIP surface and/or the at least one bead foam article is heated to adhere the at least one bead foam article to the surface.

11. The insulated shipper of claim 1, wherein the VIP is formed from polypropylene.

12. A method for producing an insulated shipper comprising:
adhering at least one bead foam article to a vacuum insulated panel (VIP) surface by heating the VIP surface and/or a surface of the at least one bead foam article and pressing the surface of the at least one bead foam article against the VIP surface,
wherein the at least one molded bead foam article comprises a plurality of foam beads comprising polylactic acid.

13. The method of claim 12, wherein the at least one bead foam article and the VIP surface are adhered together without using an adhesive.

14. The method of claim 12, wherein the at least one bead foam article is removable from the VIP surface.

15. The method of claim 12, wherein a force to remove the at least one bead foam article from the VIP surface is at least 20 psi.

16. The method of claim 12, wherein removal from the VIP surface leaves no residue on the VIP surface.

17. The method of claim 12, wherein heating the VIP surface and/or the surface of the at least one bead foam article is performed using a heating element, wherein the heating element comprises a heated roller, a heated press, a hot air gun, an infrared-emitting device, a conduction heater, an induction spot heater, steam, or a heated fluid.

18. The method of claim 12, wherein the VIP surface and/or the surface of the at least one bead foam article is heated to a temperature between or including 250° F. and 450° F.

19. The method of claim 12, wherein only a portion of the VIP surface and/or the surface of the at least one bead foam article is heated to adhere the at least one bead foam article to the VIP surface.

20. The method of claim 12, wherein the at least one bead foam article is pressed against the VIP surface for less than 5 seconds.
